(19) United States
(12) Patent Application Publication
(10) Pub. No.: US 2022/0172140 A1
(43) Pub. Date: Jun. 2, 2022

(54) SERVER DEVICE FOR COLLECTION AND DELIVERY SYSTEMS AND COLLECTION AND DELIVERY CONTROL METHOD THEREOF

(71) Applicant: TOSHIBA TEC KABUSHIKI KAISHA, Tokyo (JP)

(72) Inventors: Yumiko Okuma, Koganei Tokyo (JP); Mayuko Tsunoda, Yokohama Kanagawa (JP); Shota Konishi, Kawasaki Kanagawa (JP); Naoki Hoshino, Hasuda Saitama (JP); Kanya Hiroi, Yokohama Kanagawa (JP)

(21) Appl. No.: 17/464,363

(22) Filed: Sep. 1, 2021

(30) Foreign Application Priority Data
Dec. 2, 2020 (JP) 2020-200305

(51) Int. Cl. G06Q 10/06; G06Q 10/08

(52) U.S. Cl. CPC G06Q 10/06315; G06Q 10/087; G06Q 10/06311; G06Q 30/0635; G06Q 10/0833; G06Q 10/0834; G06Q 10/08355

(57) ABSTRACT

According to one or more embodiments, the server device includes a storage device and a processor. The storage device stores a product master. The processor stores customer information and product information related to a customer order in the storage device, assembles a collection and delivery route for one or more target products based on both store information related to one or more stores where the target products are available and the customer information and assigns collection and delivery personnel. The processor sends a server order of the target products to the stores.

### CROSS-REFERENCE TO RELATED APPLICATION

This application is based upon and claims the benefit of priority from Japanese Patent Application No. 2020-200305, filed Dec. 2, 2020, the entire contents of which are incorporated herein by reference.

### FIELD

Embodiments described herein relate generally to a server device and a non-transitory computer-readable medium.

### BACKGROUND

Some electronic commerce (EC) websites provide a service that accepts orders from service users for products at different distributors (locations) and then collects from these different locations and then delivers these products in a batch to the service user. In addition, some larger retail stores, such as supermarkets, may deliver products from the store site in response to on-line customer orders. Similarly, in recent times, the number of restaurants/stores that provide home delivery of food (or other products) prepared in the restaurant/store by linking up with a third-party delivery service or the like has increased.

While there are various services for providing home delivery to customers from individual stores/restaurants, there is a lack of services that replicate many people's normal/daily shopping routine which may include visiting and buying products from multiple stores in a single shopping trip or the like. In addition, it may be difficult, especially for smaller retail stores, such as small privately owned shops (independent small businesses), to provide or even participate in a delivery service requiring an on-line portal or the like.

### BRIEF DESCRIPTION OF THE DRAWINGS

FIG. 1 is a diagram showing a configuration example of a collection and delivery system according to an embodiment.

FIG. 2 is a diagram showing an example of a configuration of a user terminal according to an embodiment.

FIG. 3 is a diagram showing an example of a configuration of a collection and delivery staff terminal according to an embodiment.

FIG. 4 is a diagram showing an example of a configuration of a server device according to an embodiment.

FIG. 5 is a diagram showing an example of a data configuration of a store master according to an embodiment.

FIG. 6 is a diagram showing an example of a data configuration of a product master according to an embodiment.

FIG. 7 is a diagram showing an example of a data configuration of a customer management table according to an embodiment.

FIG. 8 is a diagram showing an example of a data configuration of an order management table according to an embodiment.

FIG. 9 is a diagram showing an example of a configuration of a server device according to an embodiment.

FIG. 10 is a sequence diagram showing an example of processing executed among devices and terminals of a collection and delivery system according to an embodiment.

FIG. 11 is a diagram showing an example of a guidance screen displayed on a display unit of a user terminal according to an embodiment.

### DETAILED DESCRIPTION

In general, according to one embodiment, a server device includes a storage device and a processor. The storage devices stores a product master having product information about products that can be ordered by customers and store information about stores at which the products are available. The processor is configured to: store product information related to products in a customer order in the storage device in association with customer information related to the customer order; assemble a collection and delivery route for the products in the customer order based on the customer information and the store information from the product master for one or more stores at which the products in the customer order are available; assign collection and delivery personnel to fulfill the customer order according to the collection and delivery route; and send a store order for the products in the customer order to each store in the collection and delivery route.

Hereinafter, certain example embodiments will be described with reference to the accompanying drawings. The present disclosure is not limited to these example embodiments.

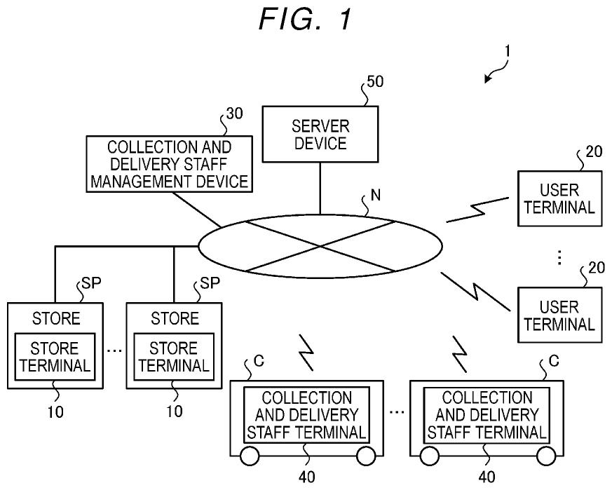

FIG. 1 is a diagram showing a configuration example of a collection and delivery system 1 according to an embodiment. As shown in FIG. 1, the collection and delivery system 1 includes a store terminal 10, a user terminal 20, a collection and delivery staff management device 30 (staff management device 30), a collection and delivery staff terminal 40 (staff terminal 40), and a server device 50. The store terminal 10, the user terminal 20, the staff management device 30, and the terminal 40 are communicably connected to the server device 50 via a network N, such as the Internet or a mobile phone line network.

The store terminal 10 is a terminal device, such as a personal computer (PC) or a POS terminal, provided at each store SP that utilizes the collection and delivery system 1. The stores SP can be stores that sell products to consumers (retail stores). The stores SP may be each of independent stores or related stores (or sites). The stores SP may be at separate locations within a city or region or may at the same shared facility such as a shopping mall. The number of store terminals 10 provided in each store SP is not particularly limited and multiple store terminals 10 may be provided at each store SP (site).

The store terminal 10 includes a processor and executes various processes related to services and businesses provided by the store SP under the control of the processor or according to one or more programs executed by the processor. For example, the store terminal 10 processes information related to checkout of products purchased by a user or a customer who has visited the store SP. The store terminal 10 also provides user's purchase history information or past purchase data to the server device 50. The purchase data includes, for example, a customer ID that identifies a user, a product ID that identifies a product that the user purchased at an actual store or ordered via a network, a store ID that identifies the store SP, purchase date and time, and other information related to the customer's product purchase in the past as appropriate. The method of acquiring the purchase data is not particularly limited, and existing technologies, such as a customer management system and an order management system, can be used.

The store terminal 10 displays a collection request notified from the server device 50 on a display device. The collection request includes, for example, a product ID, quantity or a number of orders of a product to be collected (may also be referred to as a target product), scheduled arrival date and time of collection and delivery staff (or a collection and delivery person), and other information related to the product collection as appropriate.

The user terminal (may also be referred to as a customer terminal) 20 is a terminal device used by a user, such as a customer, of the collection and delivery system 1. The user terminal 20 may be, for example, a portable terminal device, such as a smartphone or a tablet terminal. The user terminal 20 may be, for example, a stationary terminal device, such as a PC.

The user terminal 20 executes various processes in response to user's operation. The user terminal 20 can also be used as an interface device for displaying or outputting information provided by the server device 50 and transmitting or inputting information to the server device 50. For example, the user terminal 20 can send a product order, that is, transmit information of a product that a customer wishes to purchase by a collection and delivery service to the server device 50 in response to user's operation and input.

The staff management device 30 is a terminal device, such as a PC, used by, for example, a human resource management company that employs and manages personnel (referred to as collection and delivery personnel, collection and delivery staff, or a collection and delivery person) in charge of collecting an ordered product at a store SP and delivering it to a designated destination. The staff management device 30 includes a processor and executes various processes related to the management of collection and delivery staff under the control of the processor or according to one or more programs executed by the processor. For example, the staff management device 30 assigns collection and delivery staff based on a collection and delivery route provided by the server device 50, a schedule and a current location of the collection and delivery staff, and the like. The staff assignment may be done automatically by the staff management device 30 or may be entered manually into the staff management device 30. The staff management device 30 may also be referred to as a collection and delivery staff assignment device 30.

The staff terminal 40 is a terminal device used by the collection and delivery staff. The staff terminal 40 may be a portable terminal device, such as a smartphone or a tablet terminal. The staff terminal 40 may be a stationary terminal device installed in a collection and delivery vehicle C (vehicle C).

The vehicle C is for collecting the target products at one or more stores SP and delivering the collected target products to a designated place, such as user's or customer's home. One or more vehicles C may be prepared and operated by the assigned collection and delivery staff.

The staff terminal 40 assists the collection and delivery staff for the product collection and delivery in cooperation with the staff management device 30 and the server device 50. For example, the staff terminal 40 displays a collection and delivery target product (target product), a store SP that sells the target product, a collection and delivery route, and the like provided by the server device 50. The staff terminal 40 acquires the current location of the staff terminal 40 or the vehicle C and notifies the server device 50 of the acquired current location. The staff terminal 40 also manages a progress status of the product collection and delivery and notifies the server device 50 of the progress status.

The server device 50 may be provided at a data center or the like. The server device 50 may be realized by the cloud or cloud computing.

To provide a service of collecting and delivering products from one or more stores SP on behalf of a customer, the server device 50 comprehensively controls the operation of the collection and delivery system 1. For example, first, if the server device 50 receives from the user terminal 20 information about a product to be purchased via the collection and delivery service, the server device 50 regards the received information as an order for the product collection and delivery service. Then, the server device 50 assembles a collection and delivery route based on one or more orders. The server device 50 provides the contents of the received order and the assembled collection and delivery route to the staff management device 30 and requests the staff management device 30 to assign collection and delivery staff. The server device 50 receives the location information and the progress status of the product collection and delivery from the staff terminal 40. The server device 50 reports the progress status of the product collection and delivery to the user terminal 20.

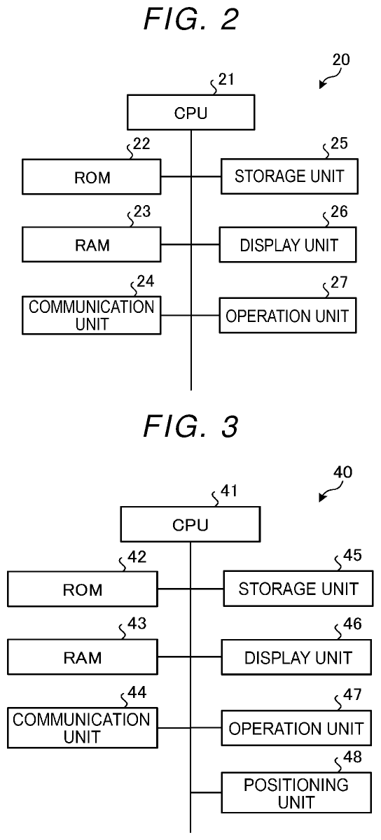

FIG. 2 is a diagram showing an example configuration of the user terminal 20. As shown in FIG. 2, the user terminal 20 includes a computer configuration having a central processing circuit (CPU) 21, a read-only memory (ROM) 22, and a random-access memory (RAM) 23.

The CPU 21 is an example of a processor and controls each unit of the user terminal 20 in an integrated manner. The ROM 22 stores various programs. The RAM 23 is a workspace for loading programs and various data.

The user terminal 20 also includes a communication unit 24, a storage unit 25, a display unit 26, and an operation unit 27. The communication unit 24 is a communication interface that can be connected to the network N. The communication unit 24 communicates with an external device, such as the server device 50, via the network N.

The storage unit 25 includes a storage medium, such as a hard disk drive (HDD) or a flash memory, and maintains the stored contents even when the power is cut off. The storage unit 25 stores programs and various setting information that can be executed by the CPU 21. For example, the storage unit 25 stores an application program prepared for the collection and delivery system 1. The CPU 21 executes various processes by operating according to a program stored in the ROM 22 or the storage unit 25 and loaded onto the RAM 23.

The display unit 26 is a display device, such as a liquid crystal display (LCD), and displays various information and screens according to the control of the CPU 21. The operation unit 27 includes various operation keys and outputs the operation contents in response to user's operation to the CPU 21. The operation unit 27 may be a touch panel provided on a surface of the display unit 26.

FIG. 3 is a diagram showing an example configuration of the staff terminal 40. As shown in FIG. 2, the staff terminal 40 includes a computer configuration having a CPU 41, a ROM 42, and a RAM 43.

The CPU 41 is an example of a processor and controls each unit of the terminal 40 in an integrated manner. The ROM 42 stores various programs. The RAM 43 is a workspace for loading programs and various data.

The staff terminal 40 also includes a communication unit 44, a storage unit 45, a display unit 46, an operation unit 47, and a positioning unit 48. The communication unit 44 is a communication interface that can be connected to the network N. The communication unit 44 communicates with external devices, such as the staff management device 30 and the server device 50, via the network N.

The storage unit 45 includes a storage medium, such as an HDD or a flash memory, and maintains the stored contents even when the power is cut off. The storage unit 45 stores programs and various setting information that can be executed by the CPU 41. For example, the storage unit 45 stores an application program or the like that can execute a payment process (for example, electronic payment) of a product. The CPU 41 executes various processes according to a program stored in the ROM 42 or the storage unit 45 and loaded onto the RAM 43.

The display unit 46 is a display device, such as an LCD, and displays various information and data according to the control of the CPU 41. The operation unit 47 includes various operation keys and outputs operation contents in response to user's operation to the CPU 21. The operation unit 47 may be a touch panel provided on a surface of the display unit 46.

The positioning unit 48 measures the location where the terminal 40 exists. The positioning unit 48 includes, for example, a position measuring device that uses a positioning technology, such as Global Positioning System (GPS).

The configuration of the staff terminal 40 is not limited to the present example. For example, the staff terminal 40 may be provided with an imaging device, such as a camera, capable of reading a code symbol, such as a two-dimensional code or a barcode.

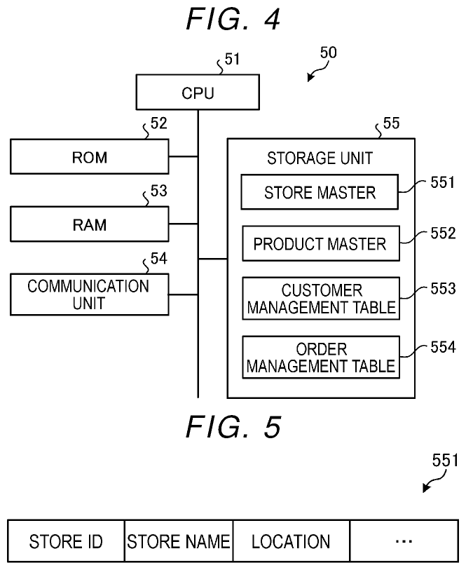

FIG. 4 is a diagram showing an example configuration of the server device 50. As shown in FIG. 4, the server device 50 includes a computer configuration having a CPU 51, a ROM 52, and a RAM 53.

The CPU 51 is an example of a processor and controls each unit of the server device 50 in an integrated manner. The ROM 52 stores various programs. The RAM 53 is a workspace for loading programs and various data.

The server device 50 also includes a communication unit 54 and a storage unit 55. The communication unit 54 is a communication interface that can be connected to the network N. The communication unit 54 communicates with external devices, such as the store terminal 10, the user terminal 20, the staff management device 30, and the staff terminal 40, via the network N.

The storage unit 55 includes a storage medium, such as an HDD or a flash memory, and maintains the stored contents even when the power is cut off. The storage unit 55 stores programs and various setting information that can be executed by the CPU 51. For example, the storage unit 55 stores a Web server program, a Web application program, or the like. The CPU 51 executes various processes according to a program stored in the ROM 52 or the storage unit 55 and loaded onto the RAM 53.

The storage unit 55 stores a store master 551, a product master 552, a customer management table 553, and an order management table 554.

FIG. 5 is a diagram showing an example data configuration of the store master 551. As shown in FIG. 5, the store master 551 stores a store name, a store location, and the like in association with a store ID of each store SP. The store ID is identification information for identifying each store SP. The location is location information indicating an address or coordinates of the store SP identified by the store ID. For example, if the store SP is in the shopping mall, the location may indicate the address of the shopping mall or the location of the store SP within the shopping mall.

The data configuration of the store master 551 is not limited to the example shown in FIG. 5. As another example, the store master 551 may store, in association with the store ID of each store SP, image information or a store image, such as an icon or a logo mark representing the identified store SP.

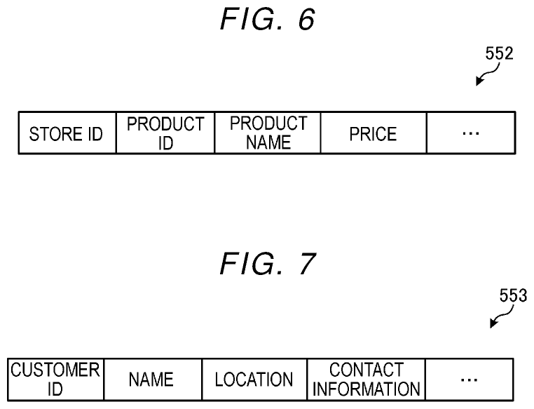

FIG. 6 is a diagram showing an example data configuration of the product master 552. As shown in FIG. 6, the product master 552 stores, in association with the store ID of each store SP, a product ID, a product name, a price, and the like of each product sold at the store SP corresponding to the store ID. The product ID is identification information for identifying a product sold at each store SP. The product name is information indicating a name or an item of the product corresponding to the product ID. The price is information indicating a unit price of the product corresponding to the product ID.

The data configuration of the product master 552 is not limited to the example shown in FIG. 6. As another example, the product master 552 may store, in association with the product ID of each product, image information or a product image, such as a photograph or an illustration representing the identified product, a description thereof, or the like.

FIG. 7 is a diagram showing an example data configuration of the customer management table 553. As shown in FIG. 7, the customer management table 553 stores, in association with a customer ID of each user, a user's name, a location, contact information, and the like corresponding to the customer ID.

The “customer ID” is identification information for identifying each service user. The “name” is information indicating the name of the user corresponding to the customer ID. The “location” is location information indicating the address or whereabouts of the user corresponding to the customer ID. The “contact information” is information indicating the contact information of the user corresponding to the customer ID. An address, telephone number, terminal ID of the user terminal 20 are registered in the contact information.

The data configuration of the customer management table 553 is not limited to the example shown in FIG. 7. As another example, the customer management table 553 may store, in association with the customer ID of each user, personal information such as the gender and age, of the user identified by the customer ID.

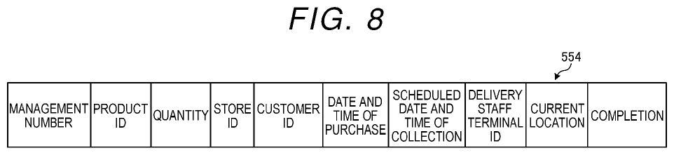

FIG. 8 is a diagram showing an example data configuration of the order management table 554. As shown in FIG. 8, the order management table 554 stores, in association with a management number, a product ID and a quantity of each ordered product (target product), a store ID of the store SP that provides the target product (or the store SP where the target product is to be collected), the customer ID of the user who placed the order of the product, purchase date and time representing date and time when the user placed the order, a scheduled time to collect the target product, a collection and delivery staff terminal ID, a current location of the staff terminal 40, and a “completion” flag indicating whether the collection and delivery process/service has been completed, and the like. The management number is unique for each combination of the product ID, the customer ID, and the purchase date and time.

The collection and delivery staff terminal ID is the terminal ID of the staff terminal 40 used by the collection and delivery staff. The collection and delivery staff terminal ID is also used as identification information of the vehicle C driven by the collection and delivery staff. The current location is of the collection and delivery staff corresponding to the collection and delivery staff terminal ID. The current location may be that of the vehicle C.

The data configuration of the order management table 554 is not limited to the example of FIG. 8. As another example, the order management table 554 may store map information indicating the location of each store SP, sales location(s) within each store SP, and the like in association with the management number.

Further, the server device 50 stores, in association with the collection and delivery staff terminal ID of the order management table 554, schedule information that defines a route and scheduled date and time of collecting the target product at each store SP. The server device 50 also stores purchase history information of each user in the storage unit 55. The purchase history information is the accumulation of past purchase data provided from the store terminal 10 of the store SP. The purchase history information includes information such as “purchase date and time” indicating the date and time when the user corresponding to the customer ID used the store SP, “store ID” of the store SP, and “product ID” of the product purchased at the store SP.

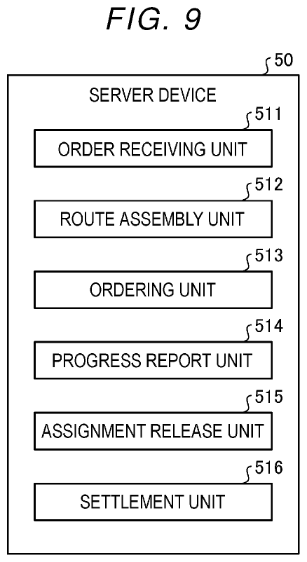

FIG. 9 is a diagram showing another example configuration of the server device 50. As shown in FIG. 9, the server device 50 includes an order receiving unit 511, a route assembly unit 512, an ordering unit 513, a progress report unit 514, an assignment release unit 515, and a settlement unit 516 as functional units.

A part or all of the functional units of the server device 50 may have a software configuration realized by cooperation between the processor (for example, the CPU 51) of the server device 50 and the program stored in the memory (for example, the ROM 52 or the storage unit 55). A part or all of the functional units of the server device 50 may have a hardware configuration realized by a dedicated circuit or the like provided in the server device 50. A part or all of the functional units may be configured by a combination of software and hardware.

The order receiving unit 511 receives an order from the user terminal 20 and stores in the order management table 554 user information and product information related to the received order based on the product master 552 that manages the product information. The order receiving unit 511 also receives designation of a delivery method among a plurality of available delivery methods for the target product. The available delivery methods include, but are not limited to, “Delivery in Shortest Time Period,” “Delivery at Designated Time,” “Shared Delivery,” and the like. In the Shared-Delivery method, a delivery fee is shared among a plurality of customers. The received delivery method designation is stored in the order management table 554 in association with the management number. The order receiving unit 511 also completes settlement payment of a product price of the ordered product with the user terminal 20 to complete the order process. The settled product price is distributed to the relevant store SP, for example, after the target product is collected and delivered.

The route assembly unit 512 calculates and assembles a collection and delivery route of the target product, that is the product related to the order stored in the order management table 554, based on the user information and the store information of the store SP where the target product is available. The route assembly unit 512 then assigns personnel to the collection and delivery task.

When assembling the route, the route assembly unit 512 takes into consideration the delivery method designation received by the order receiving unit 511. For example, the route assembly unit 512 refers to the order management table 554 and determines which delivery method has been designated for the order of the specific management number. If the management number is associated with the “Delivery in Shortest Time Period” or the “Delivery at Designated Time” in the order management table 554, the route assembly unit 512 calculates and assembles the collection and delivery route for the designated delivery method. If there are multiple orders or multiple management numbers having the same customer ID and the same purchase date and time, that is if there are multiple orders made at the same purchase date and time by the same customer, the route assembly unit 512 calculates and assembles the collection and delivery route for such multiple orders with respect to either the “Delivery in Shortest Time Period” or the “Delivery at Designated Time” specified. In another case, if there are multiple orders or management numbers that have the “Shared Delivery” specified as the designated delivery method, for example, the route assembly unit 512 combines the plurality of “Shared Delivery” orders having similar purchase dates and times for each of the store IDs and assembles one or more collection and delivery routes appropriate for completing such orders, that is, the routes capable of collecting and delivering the target products of the combined orders related to the plurality of customer IDs.

The route assembly unit 512 determines which store SP an order for the target product should be sent to, that is which store SP the target product should be collected from based on the purchase history information stored in the storage unit 55 as appropriate. For example, the route assembly unit 512 refers to the user's purchase history information, that is the information of the product that the user purchased in the past, to determine at which store SP the user purchased the same product in the past as the product ordered this time. Then, the route assembly unit 512 includes the determined store SP in the collection and delivery route on the condition that the target product ordered this time is available and can be collected at the determined store SP in light of the delivery method designation.

Once the collection and delivery route has been determined and assembled, the route assembly unit 512 predict the scheduled collection time for each order based on the assembled route and register it in the record of the corresponding management number.

The route assembly unit 512 then requests the staff management device 30 for assignment of personnel in charge of the collection and delivery of the target product (collection and delivery staff or a collection and delivery person). For example, the route assembly unit 512 transmits a request for assigning the suitable collection and delivery staff to the staff management device 30. The request includes the assembled route. The route assembly unit 512 receives a collection and delivery staff terminal ID of the assigned collection and delivery staff in return from the staff management device 30 and inputs the received ID as a collection and delivery staff terminal ID in the order management table 554.

In one instance, a human resource management company that received the notification from the server device 50 via the staff management device 30 determines the collection and delivery staff in charge of the product collection and delivery based on the notified collection and delivery route. Once the collection and delivery staff has been determined, the staff management device 30 notifies the server device 50 of the collection and delivery staff terminal ID of the staff terminal 40 used by the determined collection and delivery staff.

The ordering unit 513 places an order (may also be referred to as a server order) to one or more stores SP determined by the route assembly unit 512 for products that are to be collected at such stores SP among the target products of the user order.

In addition, the ordering unit 513 makes a collection and delivery request to the staff terminal 40 used by the collection and delivery staff. For example, the ordering unit 513 transmits, to the staff terminal 40, the collection and delivery request including information related to the collection and delivery route, the target product to be collected, the store SP that is the collection destination, and the delivery destination.

Based on the received collection and delivery request from the ordering unit 513, the collection and delivery staff using the terminal 40 and driving the vehicle C collects the target products at the respective stores SP by the scheduled date and time specified in the request. Then, the collection and delivery staff delivers the collected products to the delivery destination, such as user's home address or a destinated place, by the scheduled date and time specified in the request.

The progress report unit 514 transmits the progress status to the user terminal 20 that ordered the product collection and delivery in progress by the collection and delivery staff, based on the information related to the in-progress collection and delivery, such as location information, pick-up (or collection) notification and pick-up (or collection) completion notification, received from the staff terminal 40.

For example, the staff terminal 40 periodically transmits location information, the server device 50 receives the location information, and the progress report unit 514 transmits the location information to the user terminal 20. The staff terminal 40 also sends a pick-up notification to the server device 50 each time the target product is picked up at the collection-destination store SP and delivered to the designation. Upon receipt of the pick-up notification, the progress report unit 514 sets the “completion” flag in the corresponding record in the order management table 554. For example, the progress report unit 514 changes the flag value from 0 to 1. Further, the staff terminal 40 transmits a pick-up completion notification if all the “completion” flags of the corresponding records in the order management table 554 in association with the collection and delivery request assigned to the collection and delivery staff who possesses the staff terminal 40 are set.

After receiving the completion notification (or report) of collection and delivery of all target products, the assignment release unit 515 releases the assignment of the current collection and delivery staff so that he or she can be ready for the next collection and delivery assignment/task. For example, upon receipt of the completion notification from the staff terminal 40, the assignment release unit 515 notifies the staff management device 30 that the collection and delivery staff and the vehicle C indicated by the collection and delivery staff terminal ID have returned to a standby state and can be assigned to the next collection and delivery task.

The settlement unit 516 pays the price of the products and services to each store SP or store terminal 10 each time collection or delivery completion notification is made. This payment by the settlement unit 516 may be done at a fixed time, such as after the store is closed or before the store is opened.

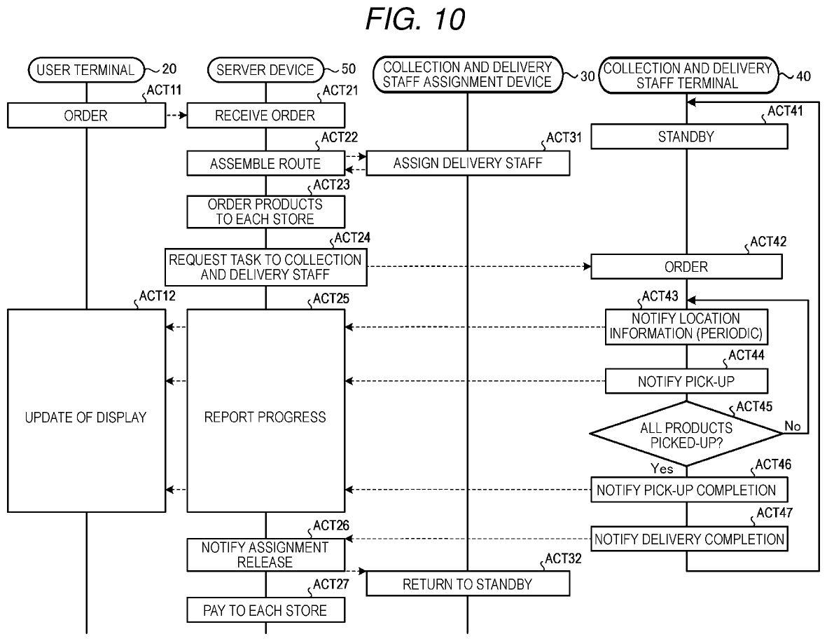

FIG. 10 is a sequence diagram showing an example of processing executed among the user terminal 20, the staff terminal 40, the staff management device 30, and the server device 50. This example processing assumes that a plurality of collection and delivery vehicles C with staff terminals 40 are in a moving state, following already-existing, in-progress collection and delivery requests.

First, when a user or a customer operates the user terminal 20 to start a dedicated application and input information related to a new order, the user terminal 20 transmits order information to the server device 50 (ACT 11). Upon receipt of the order information, the order receiving unit 511 of the server device 50 registers contents of the received order in the order management table 554 (ACT 21).

In the server device 50, the route assembly unit 512 calculates and assembles a collection and delivery route (ACT 22). The route assembly unit 512 then transmits a collection and delivery staff assignment request to the staff management device 30 together with the assembled collection and delivery route. Upon receipt of the request, the staff management device 30 selects from among the plurality of staff terminals 40 in the vehicles C which are moving, (pursuing the already-existing, in-progress requests), an appropriate staff terminal 40 at a suitable location with a suitable existing schedule as a collection and delivery route for the new request/order (ACT 31). The staff management device 30 transmits the collection and delivery staff terminal ID of the selected staff terminal 40 to the server device 50. Upon receipt of the collection and delivery staff terminal ID, the route assembly unit 512 of the server device 50 registers the received collection and delivery staff terminal ID in the record of the corresponding management number in the order management table 554.

Subsequently, in the server device 50, the ordering unit 513 places an order for the products in the customer order with the appropriate stores SP that are included in the collection and delivery route (ACT 23). The ordering unit 513 also sends a request for a new task to the staff terminal 40 corresponding to the selected collection and delivery staff terminal ID (ACT 24). The request transmitted to the staff terminal 40 includes the collection and delivery route, the store information (for example, the location and name of each store SP included in the route), information regarding the product(s) to be collected at each store SP and the quantity thereof, the scheduled collection time (or the time to visit the store SP), the scheduled delivery time, the delivery destination (for example, user's home address), and other information as appropriate.

Once the staff terminal 40 receives the collection and delivery request from the server device 50 (ACT 42), the processing related to collection and delivery of the target products by the collection and delivery staff begins. For example, in the staff terminal 40, the positioning unit 48 periodically measures and transmits the location information to the server device 50 (ACT 43). Further, each time a designated (ordered) product is picked up at a store SP on the collection and delivery route, the staff terminal 40 transmits a notification to the server device 50 that the pick-up of the particular product was completed (ACT 44). The staff terminal 40 that notified the pick-up then determines whether the pick-up of all the products related to the collection and delivery request (task) is complete (ACT 45). If there are still some products to be picked up (No in ACT 45), the staff terminal 40 returns to the process of ACT 43. If all the target products have been collected (Yes in ACT 45), the staff terminal 40 proceeds to the process of ACT 46. In ACT 46, the staff terminal 40 transmits a pick-up completion notification to the server device 50 (ACT 46) indicating that all target products have now been picked up.

When the server device 50 receives the location information notification (ACT 43), the pick-up notification (ACT 44), or the pick-up completion notification (ACT 46), the progress report unit 514 of the server device 50 transmits guidance information to the user terminal 20 (ACT 25). The user terminal 20 that receives the guidance information updates the guidance screen displayed by the display unit 26 (ACT 12).

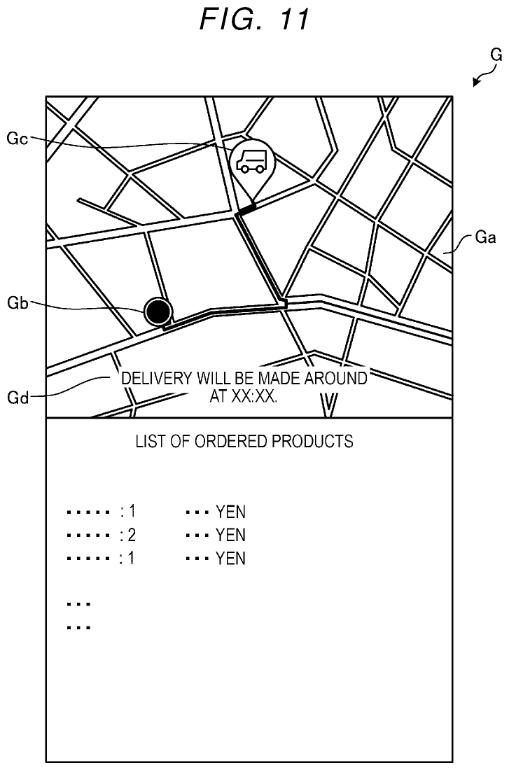

FIG. 11 is a diagram showing an example of a guidance screen G displayed on the display unit 26 of the user terminal 20. The guidance screen G is composed of, for example, two screens including an upper area for displaying a map image Ga of the target area and a lower area for displaying the details of the target product.

On the map image Ga displayed in the upper area of the guidance screen G, a mark Gb indicating a sales location and a mark Gc indicating the current location of the vehicle C are superimposed and displayed. In this example, the scheduled route to the sales location is also displayed in an overlapping manner. Further, a message Gd indicating the scheduled delivery time is superimposed and displayed on the map image Ga.

As a result, the user who operates the user terminal 20 can easily see the scheduled delivery time by looking at the upper area of the guidance screen G. Further, since the current location and the route of the vehicle C are also displayed, the user can easily perceive the approximate period of time and distance until the vehicle C reaches the sales location.

The lower area of the guidance screen G displays the name, the quantity, the price, and the like of each target product. The product name and the price are based on the information of the target product registered in the product master 552.

The display form of the guidance screen G is not limited to the example shown in FIG. 11 and may be another display form. Further, the timing at which the progress report unit 514 provides the guidance screen G or the guidance information is not particularly limited.

Accordingly, the user who operates the user terminal 20 can easily see the current location of the ordered product and the vehicle C based on the guidance information provided from the server device 50. Therefore, the server device 50 can improve the convenience of the user who uses the collection and delivery system 1.

Referring back to FIG. 10, once the products have been delivered, the staff terminal 40 notifies the server device 50 of the delivery completion (ACT 47). Upon receipt of this notification, the server device 50 or the assignment release unit 515 thereof notifies the staff management device 30 that the collection and delivery staff and the vehicle C, which correspond to the collection and delivery staff terminal ID sent with the delivery completion notification, have returned to the standby state and are ready for the next task (ACT 26). Upon receipt of this notification, the staff management device 30 updates the record related to the corresponding collection and delivery staff terminal ID to a standby state to be available for the next task (ACT 32).

Then, the server device 50 or the settlement unit 516 thereof proceeds with the payment process, according to the price of the product(s) and/or service, to each store SP involved in the now completed collection and delivery processing (ACT 27).

Accordingly, in the present embodiment, it is possible to provide a service of collecting products not only from one store but also from a plurality of stores and delivering the collected products together at the same time to a user/customer. As a result, the user can order, via the collection and delivery system 1, various products available at different stores without being limited to the products and/or services of one specific store and can receive the delivery of all the ordered products. The server device 50 can accept orders for products available at one or more stores, assemble a route for collecting and then delivering the products (target products) in the received orders, and assign personnel for product collection and delivery along the route.

The server device 50 as part of the collection and delivery system 1 can make it possible to provide a service that more closely reflects the usual shopping routine, daily shopping route, or the like of some customers in which a plurality of stores in the same vicinity or neighborhood of the customer's home are visited. It is also possible for a small retail store, such as a privately-run shop or a family-run business, to provide products via delivery based on on-line ordering rather than in-person visits.

Furthermore, since the server device 50 accepts designation of a delivery method when receiving an on-line order, the user can decide whether to shorten the time between the order placement and the delivery completion, or to reduce a fee of the collection and delivery service even if it takes more time, or to request delivery of the ordered products at a specified time.

Further, since the server device 50 determines stores where the ordered products are to be collected by referring to the purchase history of the user, it is possible to preferentially select the products available at stores that the user usually uses or prefers.

The program executed by each device, terminal, or system of the present embodiment may be incorporated in a ROM, a storage unit, or the like. The program may be recorded and provided on a non-transitory computer-readable recording medium, such as a CD-ROM, a flexible disk (FD), a CD-R, or a digital versatile disk (DVD), as a file in an installable format or an executable format.

The program may be stored on a computer connected to a network, such as the Internet, and provided by downloading via the network. The program may be provided or distributed via a network, such as the Internet.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server device, comprising:
a storage device configured to store a product master having product information about products that can be ordered by customers and store information about stores at which the products are available; and
a processor configured to:
store product information related to products in a customer order in the storage device in association with customer information related to the customer order;
assemble a collection and delivery route for the products in the customer order based on the customer information and the store information from the product master for one or more stores at which the products in the customer order are available;
assign collection and delivery personnel to fulfill the customer order according to the collection and delivery route; and
send a store order for the products in the customer order to each store on the collection and delivery route.

2. The server device according to claim 1, wherein the product master manages the product information in association with a store ID of each of the stores.

3. The server device according to claim 2, wherein the product information includes a product ID, a product name, and a price.

4. The server device according to claim 1, wherein the processor receives the customer order from a customer terminal and sends the store order to a store terminal of each of the stores.

5. The server device according to claim 1, wherein the processor is further configured to transmit an order status to a customer terminal.

6. The server device according to claim 5, wherein the order status includes at least one of a current location of an assigned collection and delivery vehicle along the collection and delivery route, a product collection notification indicating an ordered product has been picked up from a store, and a product delivery notification indicating product delivery for the customer order has been completed.

7. The server device according to claim 1, wherein the processor is further configured to:
receive a designation of a delivery method from among a plurality of available delivery methods; and
assemble the collection and delivery route and assign the collection and delivery personnel based on the designated delivery method.

8. The server device according to claim 1, wherein the processor is further configured to:
release the assigned collection and delivery personnel after receiving a delivery completion notification.

9. The server device according to claim 1, wherein the processor is further configured to:
select a store from among a plurality of stores providing the same product based on product purchase history information stored in the storage device for the customer making the customer order.

10. A non-transitory computer-readable medium storing therein a program which, when executed, causes a computer to perform processing comprising:
store, in a storage device, a product master having product information about products that can be ordered by customers and store information about stores at which the products are available; and
store product information related to products in a customer order in the storage device in association with customer information related to the customer order;
assemble a collection and delivery route for the products in the customer order based on the customer information and the store information from the product master for one or more stores at which the products in the customer order are available;
assign collection and delivery personnel to fulfill the customer order according to the collection and delivery route; and
send a store order for the products in the customer order to each store in the collection and delivery route.

11. The non-transitory computer-readable medium according to claim 10, wherein the product master manages the product information in association with a store ID of each of the stores.

12. The non-transitory computer-readable medium according to claim 10, wherein the customer order is received from a customer terminal and the store order is sent to a store terminal.

13. The non-transitory computer-readable medium according to claim 10, wherein
the processing further includes:
transmit an order status to a customer terminal, and
the order status includes at least one of a current location of an assigned collection and delivery vehicle along the collection and delivery route, a product collection notification indicating an ordered product has been picked up from a store, and a product delivery notification indicating product delivery for the customer order has been completed.

14. The non-transitory computer-readable medium according to claim 10, wherein the processing further includes:
receive a designation of a delivery method from among a plurality of available delivery methods; and
assemble the collection and delivery route and assign the collection and delivery personnel based on the designated delivery method.

15. The non-transitory computer-readable medium according to claim 10, wherein the processing further includes:
release the assigned collection and delivery personnel after receiving a delivery completion notification.

16. The non-transitory computer-readable medium according to claim 10, wherein the processing further includes:
select a store from among a plurality of stores providing the same product based on product purchase history information stored in the storage device for the customer making the customer order.

17. A collection and delivery system comprising a server device, the server device configured to:
receive a customer order for collection and delivery of one or more target products from a customer terminal via a network;
store customer information and product information related to the customer order in a storage device;
assemble a collection and delivery route for the target products, the route including one or more stores where the target products are available;
send request to a collection and delivery management device via the network to assign collection and delivery personnel to perform the collection and delivery of the target products along the assembled route; and
send a store order to a store terminal at each of the stores from which the target products are to be collected by the assigned collection and delivery personnel.

18. The collection and delivery system according to claim 17, wherein the server device is further configured to:
receive a designation of a delivery method from among a plurality of available delivery methods from the customer terminal; and
assemble the collection and delivery route and send a request to the collection and delivery management device to assign the collection and delivery personnel based on the designated delivery method.

19. The collection and delivery system according to claim 17, wherein the server device is further configured to, after receiving a completion notification of collection and delivery of all the target products from a collection and delivery personnel terminal via the network, send a request to the collection and delivery management device to release the assignment of the collection and delivery personnel to be ready for next collection and delivery assignment.

20. The collection and delivery system according to claim 17, wherein the server device is further configured to:
select the stores at which the target products are to be collected based on product purchase history information for a customer associated with the customer terminal stored in the storage device.
